(19) United States
(12) Patent Application Publication
(10) Pub. No.: US 2023/0372880 A1
(43) Pub. Date: Nov. 23, 2023

(54) POROUS MEMBRANE COMPOSITES WITH CROSSLINKED FLUORINATED IONOMER

(71) Applicant: ENTEGRIS, INC., Billerica, MA (US)

(72) Inventors: Alketa Gjoka, Medford, MA (US); Jad Ali Jaber, Westford, MA (US); David Crespo, Methuen, MA (US); Saksatha Ly, Lexington, MA (US)

(21) Appl. No.: 18/199,802

(22) Filed: May 19, 2023

Related U.S. Application Data
(60) Provisional application No. 63/344,253, filed on May 20, 2022.

(51) Int. Cl. B01D 69/12; B01D 69/02; B01D 71/36; B01D 71/68; B01D 71/26

(52) U.S. Cl. CPC B01D 69/125; B01D 69/02; B01D 71/36; B01D 71/68; B01D 71/261; B01D 2325/36; B01D 2325/20

(57) ABSTRACT

Described are porous polymeric membrane composites that contain crosslinked fluorinated ionomer at a surface of a microporous membrane support, and related methods.

### FIELD

The disclosure is in the field of filters and filter membrane composites that contain crosslinked fluorinated ionomer at a surface of a microporous membrane support, and related methods.

### BACKGROUND

Filter membranes made from porous polymeric materials are used commercially for various filtering applications, including for filtering liquids and gases.

In the manufacture of microelectronic circuits, filters made from polymeric porous membranes may be used for purifying various chemically active liquid or gaseous fluids to remove particle contamination from the fluid. A useful polymeric membrane is chemically resistant to the fluid that passes through the membrane.

A porous filter membrane that is hydrophobic, generally stated, does not easily wet with water. Filtering a liquid that will “outgas” (produce a gas) during a filtering operation can result in an amount of gas being released from the liquid within a filter device, at a surface of a filter membrane. A membrane that is hydrophobic will have greater affinity for the gas than the liquid. The gas that comes out of the liquid can accumulate and form gas pockets that adhere to the hydrophobic porous membrane surfaces and pores. As these gas pockets grow in size due to continued liquid outgassing, the gas pockets begin to displace liquid from the pores of the hydrophobic porous membrane, continuously reducing the effective filtration area of the hydrophobic porous membrane. This phenomenon is usually referred to as de-wetting of the hydrophobic porous membrane, by which fluid-wetted (fluid-filled) portions of the hydrophobic porous membrane are gradually overtaken by fluid-non-wetted, or gas-filled portions. Where de-wetting of a membrane occurs, filtering ceases.

Fluorine-containing polymers can have good chemical stability, i.e., may be chemically inert. But fluorine-containing polymers are typically hydrophobic and difficult to wet. To wet a hydrophobic membrane with water or an aqueous fluid, special operating procedures are required. A membrane may be first wet using a low surface tension organic solvent such as isopropyl alcohol, followed by contacting the membrane with a mixture of water and organic solvent, then followed by contact of the membrane with water or an aqueous fluid. The process can create large volumes of solvent waste and consume a large amount of water. Alternatively, hydrophobic membranes can be wet with water under pressure. A technique of using pressure intrusion is time-consuming, expensive, may be ineffective for tight pore membranes, and may cause rupture of thinner membranes. Moreover, this process does not ensure that a substantial portion of the pores in the membrane are completely permeated with water.

In contrast to hydrophobic porous membranes, hydrophilic porous membranes are spontaneously wet upon contact with an aqueous liquid so that a pre-use, specialized treatment of the membrane to wet the membrane is not needed. Advantageously, the hydrophilic membrane may be used for processing an aqueous liquid without a pre-use treatment with an organic solvent or pressure intrusion.

### SUMMARY

There exists ongoing need for microporous membranes with improved non-dewetting characteristics, that can be wetted with aqueous solutions, and that have good flow characteristics.

The following relates to microporous membrane composites that include a microporous membrane support and a coating on the surface of the microporous membrane support, with the coating including fluorinated ionomer. The fluorinated ionomer may be crosslinked, may contain hydrophilic groups, may be non-dewetting, and may be wettable with solutions that contain a range of amounts of methanol and water.

A crosslinked fluorinated ionomer may be formed on a microporous membrane support from a coating composition that contains various monomers, oligomers, pre-polymers, etc., that are reactive to form fluorinated ionomer, optionally including fluorinated ionomer precursor that is derived from the monomers. Monomers (“monomeric units”) that can be reacted to produce fluorinated ionomer include: i) one or more fluorinated monomers having a fluorinated group and a reactive ethylenic (unsaturated) group; ii) fluorinated monomers that contain a reactive ethylenic (unsaturated) group and a functional group that is transformable into a hydrophilic group; iii) bis-olefin crosslinker; and iv) fluorinated monomer that includes a reactive (e.g., ethylenic) group and a terminal iodine atom or a terminal bromine atom. While the coating composition may include a radical initiator, no radical initiator is required.

According to example methods, a microporous membrane composite can be prepared by applying a liquid coating composition onto a microporous membrane support and exposing the coating composition to electromagnetic radiation, e.g., ultraviolet radiation, to produce a crosslinked fluorinated ionomer on the support. Example processes involve applying the coating composition to the membrane, then causing the fluorinated ionomer to become crosslinked by exposing the fluorinated ionomer to electromagnetic radiation.

Example processes can be performed at non-elevated temperature, e.g., ambient temperature, without the need for an elevated crosslinking temperature and the presence of a radical initiator, as are required for heat-induced crosslinking systems. With lower temperature requirements of the process compared to heat-induced crosslinking techniques, the microporous membrane support material is not required to withstand exposure to a high crosslinking temperature, and the polymeric membrane support may be selected from a broader range of materials, including polymeric membrane supports that would be unstable at an elevated crosslinking temperature needed for heat-induced crosslinking.

A combination of operations to apply the coating composition to the support, and also expose the coating composition to electromagnetic radiation, can be performed in a continuous manner by continuously applying the coating composition onto a moving sheet or “web” of the microporous membrane support, then continuously exposing the moving sheet or web of membrane support to electromagnetic radiation.

In one aspect, the disclosure relates to a method of preparing a microporous membrane composite that comprises a microporous membrane support and a crosslinked fluorinated ionomer coating on a surface of the microporous membrane support. The method includes coating a microporous membrane with a liquid coating composition comprising fluorinated solvent and fluorinated ionomer dissolved or dispersed therein. The fluorinated ionomer is derived from copolymerizing reactive units that include: i) fluorinated monomer comprising a fluorinated group and ethylenic unsaturation; ii) fluorinated monomer comprising ethylenic unsaturation and a functional group that is transformable into a hydrophilic group; iii) fluorinated bis-olefin monomer, and iv) fluorinated bromo-alkyl or iodo-alkyl chain transfer agent. The method also includes exposing the coated fluorinated ionomer to electromagnetic radiation to cause the reactive units to react to form a crosslinked fluorinated ionomer.

In another aspect, the disclosure relates to a microporous membrane composite that includes a microporous membrane support and a hydrophilic, crosslinked fluorinated ionomer coating on a surface of the microporous membrane support. The crosslinked fluorinated ionomer includes: fluorinated polymer backbone, and hydrophilic groups attached to the fluorinated backbone; the hydrophilic groups comprising groups selected from —SO₃H and —COOH. The crosslinked liquid coating composition does not contain heat-activated radical initiator.

### BRIEF DESCRIPTION OF THE DRAWINGS

FIG. 1 show an example system and method for continuously coating a microporous membrane support as described.

FIG. 2 show a schematic, block diagram of example operations of a method or system as described.

FIG. 3 shows data from NMR analysis of crosslinked fluorinated ionomers prepared with and without a heat activated free-radical initiator.

FIG. 4 shows a calibration curve of absorbance of methylene blue dye solutions used in a dye binding capacity test of a porous membrane composite according to one embodiment of the invention.

All figures are not to scale.

### DESCRIPTION

The following description relates to microporous membrane composites that include a microporous membrane support and a coating on the surface of the microporous membrane support, with the coating including fluorinated ionomer. The description also relates to methods of preparing such a microporous membrane composite.

A microporous membrane composite can be prepared by applying a liquid coating composition onto a microporous membrane support and processing the coating composition to produce a desired crosslinked fluorinated ionomer at surfaces of the support. The coating composition applied to the support contains fluorinated ionomer that may be partially crosslinked, that is not fully crosslinked, and that can be further crosslinked by exposing the fluorinated ionomer to electromagnetic radiation (i.e., “fully-crosslinked”). After the fluorinated ionomer is fully crosslinked, the ionomer may be further chemically processed to “activate” the crosslinked fluorinated ionomer to add hydrophilic groups to the crosslinked fluorinated ionomer to cause the crosslinked fluorinated ionomer to become non-dewetting and to be wettable with a solution that contains only methanol and water.

The crosslinked polymer comprises: fluorinated polymer backbone, iodine atoms, bromine atoms, or a combination thereof; and hydrophilic groups attached to the fluorinated backbone. The iodine or bromine atoms are present within the polymer at locations between polymer (fluorocarbon) backbones, i.e., the iodine or bromine atoms connect one polymeric backbone to another polymeric backbone. The hydrophilic groups can be selected from —SO₃H PO₃H and —COOH groups pendant from the fluorocarbon backbone, and can be present as part of the crosslinked fluorinated ionomer at an equivalent weight in a range from 380 to 620 grams per equivalent, hydrophilic groups.

The process involves, applying a coating composition to surfaces of a microporous membrane support, and causing the fluorinated ionomer to become crosslinked (e.g., further crosslinked) by exposing the fluorinated ionomer to electromagnetic radiation, optionally and preferably without the need to expose the fluorinated ionomer to a high temperature to cause crosslinking of the fluorinated ionomer (a “crosslinking temperature”). Past methods of placing crosslinked fluorinated ionomer on a microporous membrane support involve causing fluorinated ionomer to become crosslinked by exposing the ionomer to an elevated crosslinking temperature, which may be at least 100, 120, or 150 degrees Celsius or higher, in the presence of a heat-activated radical initiator. In contrast, systems and methods of the present description are able to avoid the use of a heat-activated radical initiator, and the need to expose the fluorinated ionomer to an elevated crosslinking temperature, by instead inducing a crosslinking reaction in the fluorinated ionomer by exposing the fluorinated ionomer (applied onto surfaces of the support) to electromagnetic radiation, e.g., ultraviolet radiation, without the need for an elevated crosslinking temperature.

Compared to methods of preparing a chemically similar microporous membrane composite by exposing fluorinated ionomer to an elevated crosslinking temperature (e.g., a temperature of above 100 degrees Celsius) to cause the ionomer to become crosslinked, methods of the present description cause fluorinated ionomer to be crosslinked by exposing the ionomer to electromagnetic radiation. The use of electromagnetic radiation to cause crosslinking does not require an elevated crosslinking temperature, which can allow for useful differences in methods of preparing a microporous membrane composite, and in methods of forming a filter product that contains the microporous membrane composite.

A radiation-induced crosslinking mechanism can avoid the need to expose a coated membrane support to an elevated crosslinking temperature. Radiation-initiated crosslinking may be performed at a temperature that is below 170, 150, 120, or 100 degrees Celsius. The use of an elevated crosslinking temperature to cause crosslinking of fluorinated ionomer applied to surfaces of a microporous membrane support requires a microporous membrane support that is stable (not suffer degradation or melting) when exposed to the elevated crosslinking temperature. The need for stability of the membrane support at the elevated crosslinking temperature limits the choices available for microporous membrane supports and precludes the use of microporous membrane supports that are not thermally stable at the elevated crosslinking temperature, even if the support would be otherwise be useful.

By use of a radiation-induced crosslinking mechanism, the need for an elevated crosslinking temperature is eliminated and a microporous membrane composite can be prepared using a microporous membrane support that is not necessarily stable at an elevated crosslinking temperature, e.g., a temperature equal to or exceeding of 100, 120, 150, or 170 degrees Celsius. Useful microporous membrane supports that may not be useful for processing with a thermally-induced crosslinking mechanism, but that are useful for processing using a radiation-induced crosslinking mechanism, include polyolefins such as polyethylene (PE) and ultrahigh molecular weight polyethylene (UHPE), polyvinylidene fluoride (PVDF), and polyphenylsulfone (PPSU).

As a separate useful feature of a described system or process, a process as described that uses radiation to cause crosslinking of fluorinated ionomer coated onto a microporous membrane support can include continuous process steps, including a continuous step of applying coating composition onto a microporous membrane support and a continuous step of causing crosslinking of fluorinated monomer in the applied coating composition by continuously exposing the support with the applied coating composition to electromagnetic radiation. A described process may include a step of continuously applying coating composition onto surfaces of a moving sheet of microporous membrane support, followed by continuously exposing the moving sheet of microporous membrane support to electromagnetic radiation to cause crosslinking of fluorinated ionomer coated at the surface of the microporous membrane support. In comparison, typical filter products made using a heat-induced crosslinking technique perform a crosslinking step after a membrane composite has been converted and assembled into a filter component, e.g., a filter cartridge, by heating the filter cartridge.

Crosslinked fluorinated ionomer can be formed on a microporous membrane support by applying a coating composition that contains fluorinated ionomer ingredients, to surfaces of the support. The coating composition contains fluorinated ionomer ingredients that include monomers and may optionally include molecules that contain (are derived from) previously-reacted monomers, e.g., oligomers or pre-polymers derived from the monomers, which may be referred to as fluorinated ionomer “precursor.” Fluorinated ionomer precursor may be pre-reacted molecules formed from monomer, that are partially crosslinked, not completely crosslinked, and that may be further crosslinked (i.e., “fully crosslinked”) when exposed to electromagnetic radiation, after the coating composition has been applied to surfaces of the support. After applying the coating composition to the membrane support, the coating composition is exposed to electromagnetic radiation to initiate crosslinking of the fluorinated ionomer without the need to expose the coating composition to elevated temperature.

The terms “fluorinated” and “perfluorinated” are used herein in a manner that is consistent with the meanings of these terms within the chemical and chemical coatings arts. Fluorinated compounds include organic chemical compounds, polymers, ionomers, chain transfer agents, crosslinking agents, solvents, and the like, that have at least one carbon-bonded hydrogen atom that is replaced with a carbon-bonded fluorine atom. Fluorinated compounds include compounds that are perfluorinated. Perfluorinated compounds or perfluorocarbon compounds are chemical compounds, including polymers, ionomers, crosslinking groups, chain transfer agents and the like, that have all or essentially all carbon-bonded hydrogens atoms replaced with carbon-bonded fluorine atoms. Some residual hydrogen atoms may be present in a perfluorinated composition, e.g., less than 2 weight percent of the perfluorinated product, in some cases less than 0.5 or less than 0.25 weight percent of the perfluorinated product.

A coating composition contains chemical ingredients useful to produce fluorinated ionomer, with the ingredients being suspended, dispersed, or dissolved within a liquid medium that includes organic solvent. The ingredients include reactive units, e.g., monomers, crosslinkers, oligomers, chain-transfer agents, etc., that can be reacted to form fluorinated ionomer, optionally in combination with fluorinated ionomer “precursor” formed from the monomers. In some examples, the ingredients may be predominantly or entirely non-reacted, e.g., predominantly or entirely reactive monomer (including crosslinkers) compounds. In other examples the ingredients may contain reactive monomer and crosslinker compounds in combination with an amount of partially-reacted or partially-crosslinked ingredients that have been reacted to form fluorinated ionomer (i.e., “precursors”) that can be further crosslinked (e.g., to become “fully-crosslinked”) by exposing the coating composition, with precursor, to electromagnetic radiation.

Stated differently, the chemical ingredients of the coating composition include various combinations of monomers as described herein, and optional chemical derivatives thereof, which may be entirely un-reacted (in monomer form), or partially reacted to form pre-reacted, i.e., partially-polymerized or partially-crosslinked fluorinated ionomer “precursor.” Ingredients that include monomer (including crosslinker) and ionomer precursor may be further reacted (i.e., crosslinked) by exposing the ingredients to electromagnetic radiation to form a “fully-polymerized” fluorinated ionomer, which refers to the fluorinated ionomer after being applied to a microporous membrane support and after being crosslinked by exposure to electromagnetic radiation. As used herein, the term “fluorinated ionomer” refers to: partially-reacted (partially-crosslinked) ionomer that may be present in a coating composition, as well as fully-crosslinked ionomer that has been applied to a microporous membrane support as part of a coating composition and then subsequently crosslinked by exposure to electromagnetic radiation.

A coating composition may contain various monomers (which includes crosslinker), oligomers, pre-polymers, etc., that are reactive to form fluorinated ionomer, optionally including fluorinated ionomer precursor that is derived from the monomers. Monomers (“monomeric units”) that can be reacted to produce fluorinated ionomer include: i) one or more fluorinated monomers having a fluorinated group and a reactive ethylenic (unsaturated) group; ii) fluorinated monomers that contain a reactive ethylenic (unsaturated) group and a functional group that is transformable into a hydrophilic group; iii) bis-olefin crosslinker; and iv) fluorinated monomer that includes a reactive (e.g., ethylenic) group and a terminal iodine atom or a terminal bromine atom.

Fluorinated monomers (i) that have a fluorinated group and an ethylenic (unsaturated) group may be monomers that are fluorinated or perfluorinated, with examples including the following fluorinated unsaturated monomers: vinylidene fluoride (VDF); C₂-C₈ perfluoroolefins, e.g., tetrafluoroethylene (TFE); C₂-C₈ chloro-, bromo-, and iodo-fluoroolefins such as chlorotrifluoroethylene (CTFE) and bromotrifluoroethylene; CF₂═CFOR_{f} (per)fluoroalkylvinylethers (PAVE), wherein R_{f} is a C₁-C₆ (per)fluoroalkyl, for example trifluoromethyl, bromodifluoromethyl, pentafluoropropyl; CF₂═CFOX perfluoro-oxyalkylvinylethers, wherein X is a C₁-C₁₂ perfluoro-oxyalkyl having one or more ether groups, for example perfluoro-2-propoxy-propyl.

Useful fluorinated monomers (ii) that contain an ethylenic group and a functional group that is transformable into a hydrophilic group include: —SO₂F, —COOR, —COF, and combinations of these, wherein R is a C1 to C20 alkyl radical or a C6 to C20 aryl radical. One example is CF₂═CF—O—CF₂CF₂SO₂F. The functional groups may be converted into a hydrophilic group such as —SO₃H or —COOH, after the monomers are formed into fluorinated ionomer. Other examples are described in U.S. Pat. No. 6,354,443.

The equivalent weight of fluorinated monomer (ii) as part of a fluorinated ionomer, either fully crosslinked or partially crosslinked, may be in a range from 380 grams per equivalent (g/eq) and 620 g/eq, e.g., in a range from 500 to 600 g/eq or from 550 to 590 g/eq.

Useful bis-olefin crosslinker molecules (iii) include examples having formulae OF-1, OF-2, and OF-3, as follows.

Compounds of formula OF-1 are represented as:

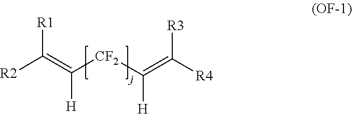

wherein j is an integer between 2 and 10, preferably between 4 and 8, and R1, R2, R3, R4 are H, F or C1 to C5 alkyl or (per)fluoroalkyl group that may be the same or different from each other. Compounds of formula OF-2 are represented as:

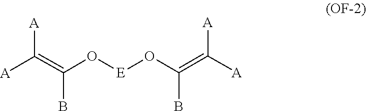

wherein each A is independently selected from F, Cl, and H; each B is independently selected from F, Cl, H, and ORB, wherein RB is a branched or straight chain alkyl radical which can be partially, substantially, or completely fluorinated or chlorinated; E is a divalent group having 2 to 10 carbon atom, optionally fluorinated, which may include ether linkages.
Compounds of formula OF-3 are represented as:

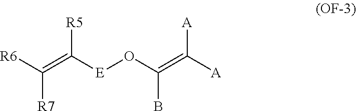

wherein E, A, and B have the same meaning as above defined; each of R5, R6, and R7 is independently H, F, or C1-5 alkyl or (per)fluoroalkyl group.

An amount of bis-olefin (iii) may be present in a mixture of ingredients used to produce fluorinated ionomer in any useful amount, e.g., an amount in a range from 0.1 to 5 weight percent bis-olefin (iii) per total weight fluorinated ionomer ingredients (including all monomers, precursors, etc.).

Useful bromine-containing and iodine-containing monomers (iii) include fluorinated chain transfer agents, e.g., of the formula R_{f}(I)ₓ(Br)_{y}, where Rfis a fluoroalkyl or (per)fluoroalkyl or a (per)fluorochloroalkyl group having from 1 to 10 carbon atoms, and wherein x and y are integers from 0 to 2, with 1≤x+y≤2. Examples include bromine-containing fluoroalkyl compounds and iodo-fluoroalkyl compounds having from 1 to 10 carbon atoms, as described for example in U.S. Pat. No. 9,359,480.

In example systems, bromine or iodine atoms may be includes in an amount in a range from 0.1 to 5 weight percent, per total weight fluorinated ionomer ingredients (including all monomers, precursors, etc.).

Optionally, but not as a requirement, a coating composition may additionally include a radical initiator that can facilitate crosslinking of fluorinated ionomer when the fluorinated ionomer is exposed to electromagnetic radiation.

Various types free-radical initiators are known to be useful for generating free radicals in a chemical system to initiate a reaction between reactants of the system, e.g., to cause crosslinking or polymerization of reactive monomers, oligomers, pre-polymers, crosslinkers, etc. Different types of free-radical initiators (or “radical initiators”) are known, which can be caused to produce one or more chemical free radicals by different activation mechanisms. Some radical initiators are activated to produce free radicals by being exposed to heat, and are referred to as “heat-activated initiators.” Other types of radical initiators are activated to produce free radicals by being exposed to electromagnetic radiation, and are referred to as “radiation-activated initiators.”

Different heat-activated free-radical initiators are known as useful for causing a reaction between chemical ingredients used to form crosslinked fluorinated ionomer. For example, U.S. Pat. No. 9,359,480 describes dialkylperoxide initiators that can be activated to produce radicals when heated to a curing temperature in a range from 100 to 300 degrees Celsius. Examples of specific dialkylperoxide initiators are identified as: di-tertbutyl-peroxide, 2,5-dimethyl-2,5-di(tertbutylperoxy)hexane, dicumyl peroxide, dibenzoyl peroxide, ditertbutyl perbenzoate, di-1,3-dimethyl-3-(tertbutylperoxy)butylcarbonate. According to the present description, a liquid coating composition is not required to include a heat-activated free-radical initiator, such as any of the general or specific initiators identified in the 9,359,480 patent. Instead, useful or preferred liquid coating compositions and derivative crosslinked fluorinated ionomers and coatings may specifically exclude these and other heat-activated free-radical initiators, e.g., may contain less than 0.001, 0.0005, or less than 0.0001 weight percent of these or any other heat-activated free-radical initiator.

To avoid the need for a step of heating the liquid coating composition to cause crosslinking of the coating composition, a liquid coating composition of the present description can be cured with a non-heat-activated method, such as by exposure to radiation, for example ultraviolet radiation having a wavelength between 300 and 400 nanometers.

Optionally, but not as a requirement, a liquid coating composition as described may include a radiation-activated free radical initiator. Examples include a class of compounds that are referred to as “Type I” photoinitiators, as well as certain types of radiation-sensitive salts, e.g., sulfites such as sodium sulfite (Na₂SO₃) that produce free radicals in the presence of ultraviolet energy.

Useful radiation-sensitive initiator compounds include Type I free-radical initiators, and comparable compounds, that are unimolecular free-radical generators that decompose to form two chemical free radicals in the presence of radiation, such as ultraviolet radiation in a range from 300 to 400 nanometers. Example Type I free-radical initiators include hydroxyacetophenone (HAP) initiators and phosphineoxide (TPO) initiators. Examples of commercially available Type I UV initiators include those that are marketed under the tradename Irgacure (e.g., Irgacure 2959, 2-hydroxy-1-[4-(2-hydroxyethoxy)phenyl]-2-methyl-1-propanone).

The presence of a radical initiator in a coating composition is optional and not required. In coating compositions that contain a radiation-activated free radical initiator, the amount of radiation-activated free radical initiator in the coating composition may be a useful amount, such as an amount in a range from 0.01 to 10 weight percent, e.g., from 0.1 to 5 weight percent, based on total weight liquid coating composition. In other examples, coating compositions may exclude any radical initiator, e.g., the coating composition may contain less than 0.01 or 0.005 or 0.001 weight percent radical initiator of any type, either heat-activated or radiation-activated.

A coating composition that contains the ingredients of fluorinated ionomer also includes a liquid medium that includes organic solvent, e.g., fluorinated solvent, in which the ingredients of the fluorinated ionomer are dissolved or dispersed. Fluorinated solvent, also referred to herein as a liquid fluorocarbon medium, is a fluorinated liquid chemical that is useful to dissolve or disperse the chemical ingredients of the coating composition to form a coating composition that when applied to porous surfaces of a microporous membrane support will wet surfaces of the support. The solvent can include fluorinated organic solvent and optionally one or more other fluorinated or non-fluorinated solvents in amounts that are effective to form a useful coating composition.

Example fluorinated solvents include, e.g., comprise, consist essentially of, or consist of, perfluoropolyether or a mixture of two or more perfluoropolyethers. A perfluoropolyether may have the general formula F₃C—O—(CF₂CF(CF₃)—O)ₙ—(CF₂—O)ₘ—CF₃ wherein m and n are integers, with n being greater than zero and m being greater than or equal to zero. Examples of such the perfluoropolyethers may have molecular weight between 300 and 600 amu and a boiling point between 20 and 150 degrees Celsius.

Other examples of useful fluorinated solvents include, e.g., comprise, consist essentially of, or consist of, hydrogenated fluoropolyether. Example hydrogenated fluoropolyethers (HFPE) can have the general formula R*—O—R_{f}′—R*′ wherein: R* and R*′ are the same or different, and are selected from: —CₘF₂ₘ₊₁ and —CₙF₂ₙ₊₁₋ₕHₕ groups, with m, n being integers from 1 to 3, h being integer that is equal to or greater than 1, chosen so that h is less than or equal to 2n+1, with the proviso that at least one of R* and R*′ is a —CₙF₂ₙ₊₁₋ₕHₕ group, as defined above; and —R_{f} is selected from:
(1) —(CF₂O)ₐ—(CF₂CF₂O)_{b}—(CF₂—(CF₂)_{z′}—CF₂O)_{c} with a, b and c being integers up to 10, preferably up to 50, and z′ being an integer equal to 1 or 2, a being greater than or equal to 0, b being greater than or equal to 0, c being greater than or equal to 0, and a+b being greater than 0; preferably, each of a and b being greater than 0, and b/a being in a range from 0.1 and 10; and
(2) —(C₃F₆O)_{c′}—(C₂F₄O)_{b}—(CFXO)ₜ—, with X being, at each occurrence, independently selected among —F and —CF₃; b, c′, and t being integers up to 10, c′ being greater than 0, b being greater than or equal to 0, t being greater than or equal to 0; preferably, b and t are greater than 0, c′/b is in a range from 0.2 and 5.0, and (c′+b)/t is in a range from 5 and 50;
(3) —(C₃F₆O)_{c′}—(CFXO)ₜ—, with X being, at each occurrence, independently selected among —F and —CF₃; c′ and t being integers up to 10, c′ being greater than 0, t being greater than or equal to 0, preferably t being greater than 0, c′/t being in a range from 5 to 50.

A useful type of fluorinated surfactant is methoxy nonafluorobutane compounds, e.g.: (CF₃)₂CFCF₂—O—CH₃ or CF₃CF₂CF₂CF₂—O—CH₃, in some cases at a purity of at least 99 percent by weight.

Examples of commercially available fluorinated solvents include: Novec™ HFE-7100 (methoxy nonafluorobutane, surface tension 13 dynes/cm available from 3M Company), Galden® SV90 (perfluoropolyether, surface tension 16 dynes/cm available from Solvay Solexis), and other similar fluorinated low surface tension solvents, combinations of these, or mixtures containing these solvents.

The coating composition may be prepared by known methods. Example coating compositions contain ingredients useful to produce fluorinated ionomer, optional fluorinated ionomer precursor, etc., which may be in the form of colloidal particles or gel particles that are suspended or dispersed in the fluorinated solvent. The particles may preferably have a small particle size, e.g., an average particle size that is less than 600 nanometer (nm), e.g., less than 300 nm, less than 125 nm, less than 40 nm, or less than 15 or 10 nm; e.g., fluorinated ionomer particles in a coating composition may have an average particle size in a range from 10 nanometers to 600 nanometers, e.g., from 10 to 300 nanometers; or from 10 to 100 or from 10 to 40 nanometers.

Relatively small ionomer particles will reduce the occurrence of particles becoming lodged in pores and blocking flow of fluid through the pores of a microporous membrane support, when the coating composition is applied to the support, which could cause a reduced rate of fluid flow through the porous membrane support (i.e., cause “flow loss”) after the crosslinked fluorinated ionomer is formed on the support to form a membrane composite.

According to some examples, useful coating compositions contain fluorinated ionomer in the form of suspended particles, with at least 90 percent by weight of the fluorinated ionomer particles having a particle size that is below 200 nanometers (nm), e.g., with at least 90 percent by weight of the fluorinated ionomer particles having a particle size that is below 125 nm, or below 40 nm, or below 15 nm.

The amount of the fluorinated ionomer ingredients in a coating composition can be an amount that will be effective, when applied to a microporous membrane support and then crosslinked and activated, to produce a microporous membrane composite that is non-dewetting, e.g., as measured by an autoclave test. Additionally, the amount can be effective to produce a microporous membrane composite that can be completely wet with a solution that contains methanol and water, or in some examples water only.

In example coating compositions, an amount of fluorinated ionomer ingredients (all non-solvent, solid ingredients including monomers, ionomer precursor, etc.) may be in a range of from 0.1 to 4 weight percent fluorinated ionomer ingredients per total weight coating composition (e.g., ionomer ingredient solids, and solvent), e.g., from 0.1 to 3.5 weight percent. A coating composition that does not contain a sufficiently high concentration of the fluorinated ionomer ingredients may produce an incompletely-coated microporous membrane support that will have un-coated hydrophobic areas and will not completely wet with a solution that contains methanol and water. A coating composition that contains too great a concentration of the fluorinated ionomer ingredients may produce a microporous membrane composite that exhibits a reduced amount of fluid flow through the membrane during use.

The microporous membrane support (i.e., “support” for short) can be formed of polymer that is chemically inert to the crosslinking and activation steps of processes described herein. A microporous membrane support is a porous membrane that may also be described by terms such as ultraporous membrane, nanoporous membrane, and microporous membrane. These microporous membranes are effective to remove undesired particle materials from a liquid feed stream, such as gel particles, colloids, cells, poly-oligomers, and the like that are larger than the pores of the microporous membrane, while components of the liquid that are smaller than the pores pass through the pores.

Examples of useful microporous membrane supports that may be considered microporous, ultraporous, or nanoporous, can have average pore sizes that may be below 10 microns, below 5 microns, or below 1, 0.5, 0.1, 0.05, or 0.01 microns.

Microporous membrane supports can have any useful thickness, e.g., from about 1 to 100 microns, or from 5 to 75 microns.

Example supports may be made of polymer that is fluorinated or perfluorinated, to be chemically inert. Examples of fluorinated microporous membrane supports include polytetrafluoroethylene (PTFE), fluorinated ethylene-propylene (FEP) copolymer, a copolymer of tetrafluoroethylene and perfluoropropyl vinyl ether (PFA, also referred to as a perfluoroalkoxy polymer), a copolymer of tetrafluoroethylene and perfluoromethyl vinyl ether (MFA), and polymer compositions comprising any of these. The microporous membrane support can for example be formed from polytetrafluoroethylene, fluorinated ethylene-propylene copolymer or a perfluoroalkoxy polymer may include the group of fluoropolymers generally known as fluorocarbons marketed by E. I. Dupont de Nemours and Company, Inc. under the names Teflon® PTFE, Teflon® FEP and Teflon® PFA or amorphous forms of Teflon® polymers such as Teflon® AF polymer.

Other fluorocarbons for the microporous membrane support may include but are not limited to those available from Daikin such as Neoflon®-PFA and Neoflon®-FEP, or various grades of Hyflon®-PFA and Hyflon®-MFA available from Solvay Solexis. Fluoropolymers have excellent chemical and heat resistance and in general are hydrophobic. Other useful thermoplastic fluoropolymers that can be used may include homopolymers and copolymers comprising monomeric units derived from fluorinated monomers such as vinylidene fluoride (VF2), hexafluoropropene (HFP), chlorotrifluoroethylene (CTFE), vinyl fluoride (VF), trifluoroethylene (TrFE), and tetrafluoroethylene (TFE), among others, optionally in combination with one or more other non-fluorinated monomers.

While fluoropolymer membrane supports are useful for processing a membrane composite at high temperatures, including by heat-induced crosslinking, example methods of the present description can be processed, including by crosslinking, without exposure to a high crosslinking temperature. By using a crosslinking step that is initiated by electromagnetic radiation, the membrane support is not exposed to a high crosslinking temperature, and heat stability is not required for the membrane support. Accordingly, a membrane support may be prepared from a polymeric material that is not necessarily stable to a high crosslinking temperature, which allows the use of membrane supports made from polyolefins such as polyethylene and ultra-high molecular weight polyethylene (UHPE), polyvinylidene fluoride (PVDF), and polyphenylsulfone (PPSU).

According to useful methods, a microporous membrane composite can be prepared by steps that include continuously applying a coating composition to surfaces of a moving microporous membrane support to form what is referred to as a “coated microporous membrane support,” or “coated support”). The coated support can subsequently be exposed to electromagnetic radiation to cause crosslinking of the fluorinated ionomer of the coating composition, also in a continuous manner. The coated support, after crosslinking, can be subsequently processed to convert the coated support into a filter membrane of a filter product. One or more of the subsequent processing steps may be performed, optionally and preferably, in a continuous manner.

In an example method, after the microporous membrane support is coated with the coating composition, and the coating composition is exposed to electromagnetic radiation to crosslink (i.e., “fully crosslink”) the fluorinated ionomer, the resultant coated support can be processed to remove excess coating composition, then to dry the support, and then to chemically convert functional groups of the fluorinated monomer to hydrophilic groups. Specific steps may include, in any useful order: after crosslinking, extracting excess (e.g., non-reacted) ingredients of the coating composition that remain at the surface to remove the excess ingredients from the coated support; drying the fully-crosslinked coating after the crosslinking and extracting steps; folding or pleating the coated membrane with fully-crosslinked fluorinated ionomer to form a pleated filter membrane from the coated support; assembling a filter product that contains the pleated membrane; and chemically transforming the functional groups of the fully-crosslinked fluorinated ionomer that are transformable into hydrophilic groups, into hydrophilic groups.

The conversion or “activation” of the transformable functional groups of the fluorinated ionomer into hydrophilic groups, for example converting sulphonyl groups —SO₂F into acid sulphonic groups SO₃H, can be carried out by known methods. By one example, activation can take place by treating the intermediate coated support with the fully-crosslinked ionomer for a time in a range from about 4 hours to about 8 hours, at a temperature in a range from about 65 degrees to about 85 degrees Celsius, in an aqueous strong base like KOH solution (e.g., at a concentration of about 10 percent by weight), then washing the treated coated support in demineralized water or deionized water at from 80 to 90 degrees Celsius to remove unreacted ionomer for 30 minutes, treating the coated support for a time in a range from about 2 hours to about 16 h at room temperature in a strong aqueous acid like HCl or nitric acid (e.g., at a concentration of about 20 weight percent), then washing coated support with demineralized or deionized water. Chemical conversion of —COF and or —COOR groups may be performed similarly. A microporous membrane support that has been coated with coating composition that contains fluorinated ionomer, which is then fully-crosslinked and then activated as described, is referred to as microporous membrane composite.

In useful and preferred examples, the fully-crosslinked fluorinated ionomer of the microporous membrane composite may contain radiation-activated radical initiator, as was included in the liquid coating composition to facilitate crosslinking of the fluorinated ionomer ingredients of the liquid coating composition.

In other useful and preferred examples, the fully-crosslinked fluorinated ionomer of the microporous membrane may exclude radiation-activated radical initiator, e.g., may contain less than 0.01 or 0.005 or 0.001 weight percent radiation-activated radical initiator.

In these and other useful and preferred examples, the fully-crosslinked fluorinated ionomer of the microporous membrane may exclude heat-activated radical initiator including any of those described in U.S. Pat. No. 9,359,480, which include dialkyl peroxide initiators that can be activated to produce radicals when heated to a curing temperature in a range from 100 to 300 degrees Celsius. Specific examples include: dialkylperoxides, such as di-terbutyl-peroxide and 2,5-dimethyl-2,5-di(tertbutylperoxy)hexane, dicumyl peroxide, dibenzoyl peroxide, ditertbutyl perbenzoate (also known as Luperox 101), di-1,3-dimethyl-3-(tertbutylperoxy)butylcarbonate. Example fully-crosslinked fluorinated ionomer of a microporous membrane of the present description may contain less than 0.01 or 0.005 or 0.001 weight percent of any heat-activated radical initiator.

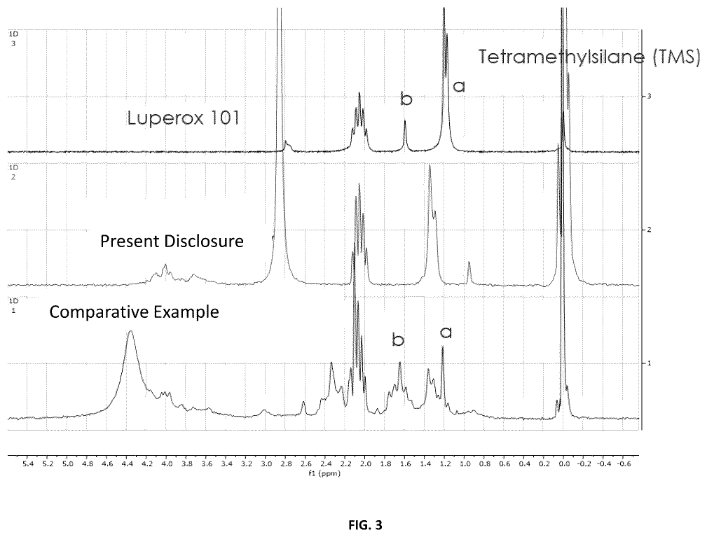

The absence, presence, and amount of a radical initiator, either of a heat-activated or a radiation-activated type, in a fully-crosslinked fluorinated ionomer of a coating of a microporous membrane composite can be determined by quantitative chemical analytic methods. One such method is nuclear magnetic resonance (NMR) analysis. See FIG. 3. Other quantitative chemical analytic methods may also be useful.

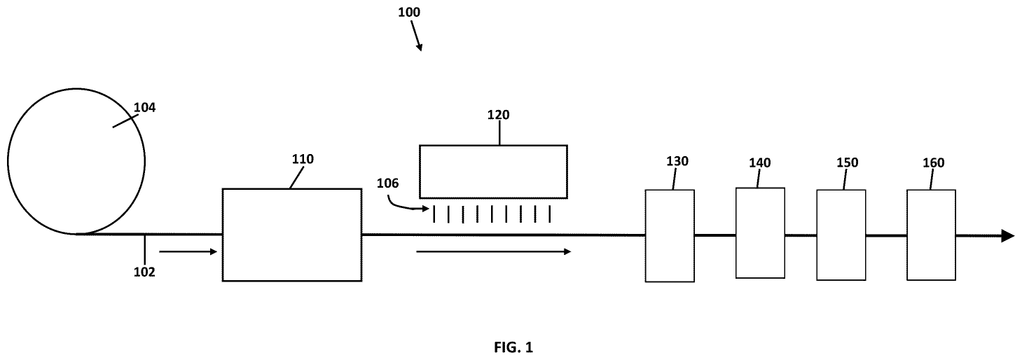

An example method is shown at FIG. 1. This example method may be performed on continuous coating line 100, with roll (104) of a continuous length of microporous membrane support 102 being aligned for un-rolling to supply a continuous moving web of support 102 to coating line 100. Downstream from roll 104 are coater 110 and electromagnetic radiation source 120. Downstream from source 120 may be various subsequent optional processing apparatuses 130, 140, 150, and 160.

In use, a web of support 102 is unwound from roll 104 and is fed to coater 110, which applies coating composition (not shown) to surfaces of support 102 while support 102 moves continuously through coater 110. Coater 110 may be of any useful type, such as a spray-coater, dip coater, curtain coater, optionally with mechanical devices such as rollers or squeeze bars that cause the coating composition to be fully impregnated into pores of support 102 for uniform coating of all surfaces of support 102. A particularly useful type of coater 110 can be a bath that contains a volume of the coating solution within a vessel. Support 102 can be continuously moved through and submersed in the volume of coating composition contained in the bath, to impregnate and uniformly coat all surfaces of the porous support. The liquid composition in coater 110 may be kept at a temperature in a range from about 19 to about 26 degrees Celsius.

After the coating composition has been applied to surfaces of microporous membrane support 102, the resultant support (“coated support”) can be passed through electromagnetic radiation to cause the fluorinated ionomer of the coating composition to become crosslinked (i.e., “fully-crosslinked”) by exposure to the radiation. Coated support 102 moves in a continuous fashion through coater 110, then through electromagnetic radiation 106 emitted by electromagnetic radiation source 120. The resultant coated supported includes a coating of fully-crosslinked fluorinated ionomer.

Subsequent steps of processing the coated support, after the crosslinking step, can include removing un-reacted or excess ingredients from the coating composition that remains on surfaces of support 102, which may be done by an extractor 130 that contain a solvent, for example isopropyl alcohol. Subsequently, solvent may be removed from the remaining coating of coated support, e.g., by use of drier 140 at elevated temperatures.

After drying the coating, the coated support can be mechanically converted to form a filter membrane, e.g., by folding or pleating the dried coated support to form a pleated filter membrane, illustrated by converter 150. The pleated filter can then be incorporated into a filter device and then chemically processed to transform the functional groups of the fully-crosslinked fluorinated ionomer that are transformable into hydrophilic groups, into hydrophilic groups, which is illustrated to occur using apparatus 160 (which may be a single apparatus or a multiple apparatuses).

A microporous membrane composite as described may be used as a component of a filter device that includes various filter structures such as supports, an outer cylindrical housing or “cage,” a frame, an inner cylindrical support or “core,” as are known with various configurations in filter devices. The microporous membrane composite can be pleated in a layered configuration with one or more support layers or nets, and potted with a cage, a support, and a two endcap structures to form filter cartridges. The cartridges may be of a type that is replaceable within a filter housing, or may be securely bonded to a filter housing.

Still referring to the example system and method of FIG. 1, during all steps, the temperature of microporous membrane support 102 can be maintained at a temperature that does not cause degradation of the support, e.g., that does not exceed 170, 150, 120, or 100 degrees Celsius.

In example methods of preparing a composite, a coating composition can be applied to a microporous membrane support by a method that causes the coating composition to be coated to contact “fluid-contacting surfaces” of the membrane support, which include exterior surfaces and internal pore surfaces. Preferably, the coating composition can be applied to the support in a manner that causes the coating composition to contact all or substantially all of the surfaces of the support, to uniformly coat all surfaces of the support.

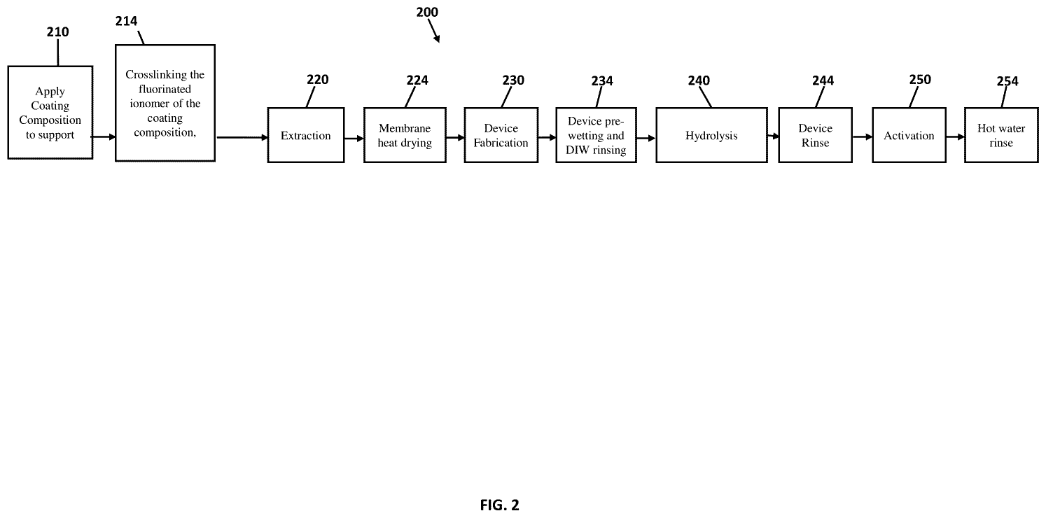

An example method 200 is shown schematically as a block diagram at FIG. 2. As illustrated, a coating operation (210) is used to apply a coating composition as described herein to a microporous membrane support. The coating composition may be applied using any effective method and equipment, such as any one or more mechanical coating and impregnation techniques to coat external and internal pore surfaces a microporous membrane support. The coating operation may be performed in a batch or semi-batch process but is preferably performed in a continuous manner by applying the coating composition onto a moving web of the microporous membrane support. Effective techniques used alone or in combination may include: spraying, roller coating, submersion by continuously passing a moving web of the membrane support through a bath of the coating composition. In some examples of a method and microporous membrane support, the support can be patterned by masking so that an unmasked portion of the microporous membrane support becomes coated with the coating composition, while masked portions of the support remain un-coated.

A coating operation 210, including a specific step of applying a coating composition to a membrane support, can be performed at any useful conditions and temperature, typically with a coating composition having a temperature in a range of ambient temperature, e.g., below 40 degrees Celsius or below 30 or 25 degrees Celsius. During a continuous coating operation, particularly after applying coating composition to a support at operation 210, and before a subsequent crosslinking operation 214, evaporation of solvent from the coating composition, or drying of the coating composition, is undesirable. To prevent solvent from evaporating out of the coating composition present on the support, and to prevent drying of the coating composition present on the support, elevated temperatures of the coating composition and support may preferably be avoided. Additionally, solvent of the coating composition may be selected to have a relatively high boiling point, a relatively low vapor pressure, or both.

In a crosslinking operation, 214, the coated support can be placed between radiation-transparent films for added support and the combination can be passed through electromagnetic radiation that will cause ingredients of the fluorinated ionomer in the coating composition to become crosslinked, i.e., “fully-crosslinked.” The coated support can be passed continuously through a chamber that is illuminated with electromagnetic radiation, e.g., ultraviolet radiation, having a wavelength and in an amount to cause desired crosslinking of the fluorinated ionomer contained in the coating composition. The crosslinking operation 214 can be performed at any useful conditions and temperature. To avoid thermal degradation of a temperature-sensitive support, if used, an interior of a crosslinking chamber (“UV chamber”) can be maintained at a temperature that does not allow the support to reach a temperature above than 170, 150, or 120 degrees Celsius.

After the fluorinated ionomer has been exposed to radiation to be fully crosslinked, subsequent steps can be performed on the coated support to convert the coated support into a filter membrane (composite) that includes a dried coating having fully-crosslinked fluorinated ionomer, with the fluorinated ionomer containing hydrophilic groups that cause the membrane composite to exhibit desired wetting (with methanol and water) and non-de-wetting properties.

As an example of a useful subsequent step, a coated support having fully-crosslinked fluorinated ionomer on surfaces thereof may be processed by one or more chemical extraction steps 220 to remove un-reacted, excess chemical ingredients from the fully-crosslinked coating composition present at support surfaces. The extraction may be performed by use of a liquid such as water (e.g., deionized water), organic solvent (e.g., isopropyl alcohol), or a combination of these, in a single step or in a series of two or more steps that each may use the same or a different liquid (e.g., solvent or water). An extraction step may be performed at ambient temperature, e.g., below 40, 30, or 25 degrees Celsius. The liquid can be caused to contact the support by spraying, by submersing the support in the liquid, and with optional mechanical agitation such as by the use of pressure, e.g., from rollers, a squeegee, or the like. Effectively, with one or more extraction steps, a large portion of excess ingredients of the coating composition can be removed from the surface of the coated support.

After an extraction step, e.g., 220, the coated support may be dried to remove solvent from the surface and crosslinked fluorinated ionomer coating. A drying step (224) can be performed by exposing the coated support (after extraction) to an elevated temperature for a time sufficient to remove residual solvent, e.g., by passing the coated support through an oven or a heated chamber that contains a heated environment. To avoid thermal degradation of a heat-sensitive support, if used, the temperature of the heated environment can be in a range that does not allow the support to reach a temperature at which thermal degradation would occur as the support moves through the heated environment, e.g., the environment may be at a temperature that does not exceed 170, 150, or 120 degrees Celsius.

The dried coated membrane can be processed by folding, cutting, pleating, or the like, in a converting and device fabrication step 230. In this step, the coated support contains fully-crosslinked fluorinated ionomer that includes functional groups that are chemically transformable into hydrophilic groups, e.g.: —SO₂F, —COOR, —COF, or a combination of these, wherein R is a C1 to C20 alkyl radical or a C6 to C20 aryl radical. These groups remain as part of the fluorinated ionomer and can be converted to hydrophilic groups as desired. A converting operation 230 may produce individual filter membranes from the coated support, and each individual membrane can each be incorporated into a single filter product such as a filter cartridge or a filter housing. The converting operation may also include assembling the coated support into a filter device such as a filter cartridge or a filter housing.

By example method 200, the functional groups of the fluorinated ionomer that are chemically transformable into hydrophilic groups can be transformed into hydrophilic groups after the coated support has first been converted to a folded or pleated coated membrane form, and after the converted (e.g., pleated) coated support is incorporated into a filter device such as a filter cartridge or a filter housing.

A first step of chemically transforming the functional groups into hydrophilic groups can be wet or “pre-wet” the coated support by a pre-wetting operation 234. To perform a pre-wetting step, a liquid that contains solvent (e.g., IPA) or water or both can be passed through the device and passed through the membrane, e.g., at ambient conditions.

In a subsequent hydrolyzing step, 240, a base such as ammonium hydroxide or potassium hydroxide can be held in contact with the membrane, e.g., at ambient temperature, for an amount of time sufficient to chemically convert the functional groups to include a potassium or —NH₄ ionic counterion. The device may then be rinsed with water, 224, to remove ammonium hydroxide or potassium hydroxide. The membrane is then contacted with an acid, 250, such as hydrochloric acid (HCl), to convert the functional groups to hydrophilic (acid) groups. A final hot water rinse 254 is applied to the coated support.

During all steps of an example method 200, the temperature of the microporous membrane support can be held below a temperature at which the support may be thermally degraded, e.g., the temperature of the support may be held below 170, 150, 120, or 100 degrees Celsius.

A membrane composite as described, prepared as presented herein, can have properties that are useful for a filter membrane composite of a type that is considered to be “non-dewetting.” A non-dewetting property of a microporous membrane composite can be determined by heating a microporous membrane composite sample that has been contacted and wet with a liquid, in an autoclave, to a temperature that is above the boiling point of the liquid. If a sample remains wet and translucent following a specific amount of time in autoclave treatment at the elevated temperature, the sample may be considered to be non-dewetting for those autoclave conditions. For example, a microporous membrane composite that does not dewet when subject to autoclave treatment in water at a temperature of 135 degrees Celsius, or higher, in water, for 40 minutes to 60 minutes or about 60 minutes, may be considered to be non-dewetting for those conditions.

A microporous membrane composite sample can be prepared for autoclave testing by first wetting the sample with a liquid, e.g., a solution that contains methanol and water, and then exchanging the methanol and water solution with water by flushing. The water-exchanged sample can be autoclaved in a sealed container with water in an oven. If a microporous membrane support is not coated with sufficient crosslinked ionomer, subjecting such an incompletely-coated sample to the autoclave treatment in water will cause the incompletely coated sample to de-wet and appear opaque following the autoclave treatment. Non-dewetting differs from contact angle measurements of a microporous membrane's surface energy because non-dewetting refers to the wetting property of the microporous membrane throughout the membrane's thickness and pores, its liquid contacting filtration surfaces, rather than just an outer surface of the microporous membrane.

A different wetting property of the filter membrane composite is the ability of the composite to become wet (wetted) with a solution of water and methanol. While a membrane composite may not be capable of being wet directly with water, example microporous membrane composite may become wet by, i.e., is “wettable” by, a solution that contains methanol and water.

The term “wettable” is used to refer to microporous membrane composites in a dry state that readily imbibe or absorb solutions that containing a combination of methanol and water, e.g., a solution that consists essentially of methanol and water, into substantially all of its coated microporous structure within 5 seconds, without the use of heat, pressure, mechanical energy, surfactant, or other prewetting agents.

Microporous membrane composites of the present description are not necessarily directly wettable with water, even though the fully-crosslinked fluorinated ionomer coating that has been formed at surfaces of the composite has hydrophilic groups, and the composite is non-dewetting following an autoclave treatment with water.

Wettability can be measured by placing a single droplet of a methanol and water solution onto a portion of a microporous membrane composite sample from a height of about 5 centimeters or less, directly onto the sample. The time for the droplet to penetrate the pores of the sample is measured. A sample is considered to be wettable by the methanol and water solution droplet if the droplet penetrates the pores of the sample within 5 seconds and the sample appears transparent. If the droplet does not penetrate the microporous membrane composite sample, a methanol and water solution containing a higher weight percentage of methanol is used to retest the sample.

Example microporous membrane composites of this description can be wet with a methanol and water solution containing 95 weight percent or less methanol, e.g., by a methanol and water solution that contains 95, 92, 90, 87, 85, 82, 80, 77, 75, 72, 50, 30, or 20 weight percent methanol with the balance being water. A microporous membrane composite that is wettable with a solution that contains an amount of methanol at the lower end of these amounts, i.e., that contains a lower relative amount of methanol, has a relatively higher surface energy and is a higher resistance to dewetting. In some examples, a microporous membrane composite as described can be wettable with a methanol and water solution that contain less than 10 or 5 weight percent methanol in water, or with pure water (99 or 100 percent water).

Microporous membranes composites as described, that are wettable with these methanol and water-containing solutions, can be used in an aqueous filtration application, where an aqueous liquid flows through the membrane without the membrane becoming de-wetted. “Aqueous liquids” are liquids that contain some amount of water, and include aqueous liquids that are known and used in the semiconductor industry, such as SC1 or SC2 cleaning baths; concentrated sulfuric acid with or without an oxidizer such as hydrogen peroxide or ozone; other aqueous based liquids in need of filtration such as aqueous solutions of a salt (buffered oxide etch), a base or an acid.

Considered in terms of surface tension, at least approximately, a microporous membrane composite that has a surface energy of 25 dynes/cm or more may be wettable with a solution that contains 80 weight percent methanol in water; a microporous membrane composite that has a surface energy of 40 dynes/cm or more may be wettable with a solution that contains 30 weight percent methanol in water; a microporous membrane composite that has a surface energy of 50 dynes/cm or more may be wettable with a solution that contains 15 weight percent methanol in water. Example microporous membrane composites of the present description can have a surface energy of at least 25 dynes per centimeter, or at least 27, 30, 32, 35, 37, 40, 45, 50, 55, 60, 65, 70, or 72 dynes per centimeter (a membrane may wet in 100 percent de-ionized water and 0 percent methanol).

The fully-crosslinked fluorinated ionomer coating on the microporous membrane support prevents dewetting of the membrane during exposure of the microporous membrane composite to gases such as air, as long as the microporous membrane composite is not exposed for a period of time sufficiently long to cause drying of the microporous membrane composite. During use in a filtration process, the filter can be exposed to air under small pressure differentials across the filter such as during a replacement of the liquid being filtered. Further, the microporous membrane composites in versions of this disclosure are particularly useful for filtering chemically active aqueous liquids such as acids or bases including those that can contain an oxidizer that produce gases or contains high concentrations of dissolved gases. In these instances, both the microporous membrane support and the crosslinked ionomer composition are resistant against chemical degradation, do not exhibit undue flow loss, and provide a microporous membrane composite that is non-dewetting.

The present disclosure will be further described with respect to the non-limiting examples below.

### Example 1

Porous membrane composites were prepared according to the present description, and tested for filtering, wettability, flow, and other performance and physical properties. Examples are listed at Tables 1 through 4 below. Specifically, the data from Table 1 show UV curing worked for a variety of polymeric membranes including thermally stable membranes (PTFE) and heat sensitive membranes (UPE and PPSU) without the use of a radical initiator. It also shows that the crosslinked coating increased surface hydrophilicity of the membrane as evidenced by lower methanol concentration needed to wet the surface of the membrane. The data from Table 2 show that UV curing also works when a radiation-activated radical initiator, such as Irgacure, was included. It also shows that the crosslinked coating increased surface hydrophilicity of the membrane as evidenced by lower methanol concentration needed to wet the surface of the membrane. The data from Table 3 and 4 show that there was no coating loss when relied solely on UV for the crosslinking versus including a radiation-activated radical initiator such as Irgacure or Na₂SO₃.

Membrane isopropanol (IPA) flow times as reported herein are determined by measuring the time it takes for 500 ml of isopropyl alcohol (IPA) fluid to pass through a membrane with a 47 mm membrane disc with an effective surface area of 17.35 cm2, at 14.2 psi, and at a temperature of 21° C.

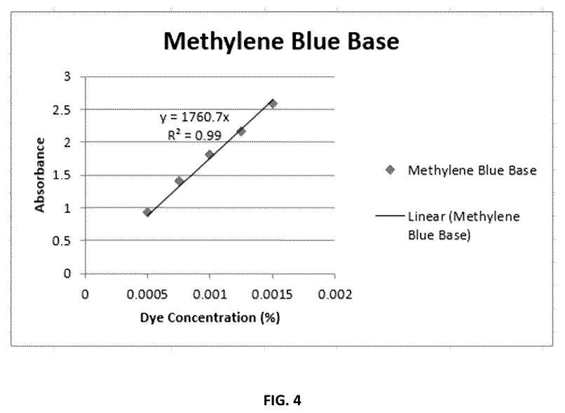

Dye Binding Capacity Test was determined as follows. Dye binding capacity measures the quantity of functional groups or the amount of charge on membrane. Methylene blue dye is used to distinguish negative charge on the surface of membrane media. A dry 25 mm disk membrane cut from modified membrane sheet was pre-wetted with isopropyl alcohol rinsed with DI water and placed on a 50 ml vial containing 0.00075 wt % methylene blue dye (Sigma) in DI water. The membrane disk was soaked for 2 hours with continuous mixing at room temperature. The membrane disk was then removed, and the absorbance of the dye solution was measured using a Cary spectrophotometer (Agilent Technologies) operating at 606 nm and compared to the absorbance of starting solution (before membrane soaking). The dye is cationic in nature and binds to the negatively-charged membrane to produce membrane with dye binding capacities shown in the Tables 1-4. In comparison, unmodified membrane typically shows a dye binding capacity of less than 0.3 ug/cm2. The slope of the calibration curve depicted in FIG. 4 was used to convert dye solution absorbance data before and after soaking the membrane, to wt % of dye, which is then converted to the mass of dye bound per membrane unit area. A calibration curve showing the absorbance of four methylene blue dye solutions with known concentrations determined using a Cary Spectrophotometer operating at 660 nm wavelength (y=1760.7x) is shown in FIG. 4.

Stability (percent coating loss), as shown at Table 3, was measured as follows: A 47 mm diameter sample of modified/coated microporous membrane is mounted in a stainless-steel membrane holder, disc area of about 17.4 cm². A mixture of hot isopropyl alcohol at a temperature from, about 75° C. to about 80° C., containing 2500 parts per million of the fluorosurfactant, FC 4432 from 3M™ Novec™, was recirculated through the modified microporous membrane sample. The surfactant-containing mixture was recirculated at a flow rate of at least 80 ml/min, depending on pore size this flow could range from about 80 milliliters per minute to about 120 milliliters per minute, for 5 hours from a volume of the IPA/Fluorosurfactant bath that was about 250 milliliters. Some bath volume loss occurred due to evaporation and was about 12% in 5 hr. After flow through of the hot IPA/fluorosurfactant, coated microporous membrane sample was washed with IPA and allowed to dry. Dye binding capacity measurement were completed on samples exposed to hot IPA FS for 5 hr and data was compared to modified/coated control.

A “wettability” test can be used to characterize the surface energy of the microporous membrane composites. The composition of the liquid used to wet the surface of the microporous membrane composites is related to the surface energy (dynes/cm) of the microporous membrane composites. To perform the tests, liquid solutions of various weight percentages of methanol and water are prepared. A drop of the liquid solution is applied to a sample of the modified/coated microporous membrane composite. The composite is considered to be wettable with the solution if in 5 seconds or less the test sample membrane changes from opaque to translucent thereby indicating that the membrane was wet with the MeOH/water solution. If wetting of the microporous membrane composite sample did not occur, a solution containing a greater amount of MeOH was used. If wetting did occur, a solution containing a lesser amount of MeOH was used. Various solutions containing methanol and water were used to evaluate the sample microporous membrane composite; the weight percent of methanol in the solution that wet the sample was reported.

Porosimetry Bubble Point (“HFE Mean BP”)

A porosimetry bubble point (“HFE mean BP” in the tables below) test method measures the pressure required to push air through wet pores of a porous membrane. A bubble point test is a well-known method for determining the pore size of a membrane.

This example describes the porosimetry bubble point test method that is used to measure the pressure required to push air through the wet pores of a membrane.

The test was performed by mounting a 47 mm disk of a dry membrane sample in a holder. The holder is designed in a way to allow the operator to place a small volume of liquid on the upstream side of the membrane. The dry air flow rate of the membrane is measured first by increasing the air pressure on the upstream side of the membrane to 160 psi. The pressure is then released back to atmospheric pressure and a small volume of ethoxy-nonafluorobutane (available as HFE 7200, 3M Specialty Materials, St. Paul, Minn., USA) is placed on the upstream side of the membrane to wet the membrane. The wet air flow rate is then measured by increasing the pressure again to 160 psi. The bubble point of the membrane is measured from the pressure required to displace HFE from the pores of the HFE-wet membrane. This critical pressure point is defined as the pressure at which a first non-linear increase of wet air flow is detected by the flow meter.

An HFE mean BP of a membrane of the present description, containing a coating of the crosslinked fluorinated ionomer, is approximately equal to an HFE mean BP of a starting (uncoated) membrane, e.g., is not more than 1 or 2 psi different from the starting membrane. An example of a range of HFE mean bubble point for membranes created by the processes described herein is below 100 psi, e.g., from 25 psi to about 90 psi as shown in Table 1.

TABLE 1

| | Substrate | | | | Modified | | | |
|---|---|---|---|---|---|---|---|---|
| | IPA Flow | | | | Membrane | | | |
| | Time in | | | | IPA FT in | | | |
| | (sec) at 14.2 | Substrate | | | sec at 14.2 | % Flow | Dye | |
| | psi/500 | HFE mean | Ionomer | | psi/500 | rate | binding | Wettability |
| | ml/17.35 | PB | Concentration | Radical | ml/17.35 | reduction | capacity | (CH₃OH/H₂O) |
| Membrane | cm2RT | (psi) | (% Wt) | Initiator | cm2/RT | after SM | (ug/cm2) | (weight percent) |
| PTFE | 160 | 25 | 0.2 | None- | 350 | 54 | 39-47 | 35-47% |
| | | | | UV cured | | | | |
| PTFE | 160 | 25 | 0.5 | None- | 383 | 58 | 58-72 | 25-30% |
| | | | | UV-cured | | | | |
| PTFE | 235 | 30 | 3 | None | 995 | 76 | 82 | 0% - Fully wets |
| | | | | UV-cured | | | | in DI Water |
| PTFE | 1027 | 74 | 0.3 | None | 2851 | 27 | 13 | 92 |
| | | | | UV-cured | | | | |
| UPE | 3786 | 89 | 0.3 | None | 3547 | 50 | 20 | 45 |
| | | | | UV-cured | | | | |
| PPSU | 631 | 86 | 0.3 | None | 839 | 25 | 5 | 15 |
| | | | | UV-cured | | | | |

TABLE 2

| | Substrate | | | | Modified | | | |
|---|---|---|---|---|---|---|---|---|
| | IPA Flow | | | | Membrane | | | |
| | Time in | | | | IPA FT in | | | |
| | (sec) at 14.2 | Substrate | | | sec at 14.2 | % Flow | Dye | |
| | psi/500 | HFE mean | Ionomer | | psi/500 | rate | binding | Wettability |
| | ml/17.35 | PB | Concentration | Radical | ml/17.35 | reduction | capacity | (CH₃OH/H₂O) |
| Membrane | cm2RT | (psi) | (% Wt) | Initiator | cm2/RT | after SM | (ug/cm2) | (weight percent) |
| PTFE | 160 | 25 | 0.2 | UV + | 460 | 65 | 44 | 50-53% |
| | | | | Irgacure | | | | |
| | | | | @0.3% Wt | | | | |
| PTFE | 160 | 25 | 0.5 | UV + | 513 | 69 | 55 | 30-35% |
| | | | | Irgacure | | | | |
| | | | | @0.3% Wt | | | | |
| PTFE | 732 | 100 | 0.5 | UV + | 2678 | 74 | 35 | 30% |
| | | | | Irgacure | | | | |
| | | | | @0.25% Wt | | | | |
| PTFE | 732 | 100 | 0.5 | UV + | 4092 | 80 | 43 | 30-35% |
| | | | | Irgacure | | | | |
| | | | | @0.3% Wt | | | | |

TABLE 3
Coating Stability in hot IPA/2500 ppm Fluorinated Surfactant. Percent
loss of coating after 5 hours flow through recirculation.

| | Mem- | Coating | | DBC | DBC | |
|---|---|---|---|---|---|---|
| | brane | Concen- | | (ug/ | (ug/ | % |
| Mem- | HFE BP | tration | Radical | cm2) | cm2) | Coating |
| brane | (psi) | % Wt | Initiator | before | after | Loss |
| PTFE | 25 | 0.2 | UV only | 47 | 47 | 0 |
| PTFE | 25 | 0.2 | UV + | 46.3 | 44 | 5 |
| | | | Irgacure | | | |
| | | | @0.3% Wt | | | |

TABLE 4

| | Substrate | | | | Modified | | | | |
|---|---|---|---|---|---|---|---|---|---|
| | IPA Flow | | | | Membrane | | | | |
| | Time in | | | | IPA FT in | | | | |
| | (sec) at 14.2 | Substrate | | | sec at 14.2 | % Flow | Dye | | |
| | psi/500 | HFE mean | Ionomer | | psi/500 | rate | binding | Wettability | % Coating |
| | ml/17.35 | PB | Concentration | Radical | ml/17.35 | reduction | capacity | (CH₃OH/H₂O) | loss in hot |
| Membrane | cm2RT | (psi) | (% Wt) | Initiator | cm2/RT | after SM | (ug/cm2) | (weight percent) | IPA/FS |
| PTFE | 168 | 25 | 0.2 | UV only | 350 | 54 | 39-47 | 35-47% | 0 |
| PTFE | 160 | 25 | 0.2 | UV + | 258 | 38 | 41 | 53% | 13% |
| | | | | Na₂SO₃ | | | | | |
| | | | | @5% Wt | | | | | |

### Example 2

Referring to FIG. 3, illustrated is nuclear magnetic resonance data taken from three different crosslinked fluorinated ionomers prepared from different liquid coating composition.

At FIG. 3, the top line, labeled “Luperox 101,” (ditertbutyl perbenzoate) is a reference line for the Luperox 101 heat-activated free radical initiator. The middle line, “Present Disclosure,” is data taken from a crosslinked fluorinated ionomer prepared from a liquid coating composition disclosed herein that did not contain any Luperox 101 or other heat-activated free radical initiator, and was crosslinked by exposing the liquid coating composition to ultraviolet radiation to initiate the crosslinking reaction. The bottom line, labeled “Comparative Example,” is data taken from a crosslinked fluorinated ionomer prepared from a liquid coating composition that contained Luperox 101 in accordance with Example 6 of U.S. Pat. No. 9,359,480, which is hereby incorporated by reference in its entirety, and was crosslinked by exposing the liquid coating composition to elevated temperature to initiate the crosslinking reaction.

The two different examples, “Present Disclosure,” and “Comparative Example,” were prepared as follows:
Surface modified PTFE membranes using the liquid compositions noted above
were soaked in acetone for 4-days at 25 deg C. (˜5 wt. %); and
The extracted acetone was evaporated and the residue was re-dissolved in acetone
(D6) and the samples were tested by NMR.

The data from the samples is at FIG. 3. Generally, FIG. 3 shows that free-radical molecules such as Luperox 101 can be detected by using NMR analysis, if the molecule is present in a crosslinked, fluorinated ionomer coating. The top line shows peaks a and b, which are characteristic of the Luperox 101 free radical initiator molecule. The second line shows that the two peaks indicating the Luperox 101 molecule, at a and b, are present in the “Comparative Example” Sample. The third line shows that the two peaks that are characteristic of the Luperox 101 molecule, at a and b, are not present in the “Present Disclosure” sample. This data illustrates that NMR analysis can be used to determine if a heat-activated radical initiator, such a Luperox 101, is present in the crosslinked fluorinated ionomer coating.

Aspects:

In a first aspect, a microporous membrane composite comprises a microporous membrane support; and a hydrophilic, crosslinked fluorinated ionomer coating on a surface of the microporous membrane support, the crosslinked fluorinated ionomer comprising: fluorinated polymer backbone, and hydrophilic groups attached to the fluorinated backbone, wherein the hydrophilic groups comprise groups selected from —SO₃H, —COOH, and PO₃H, wherein the crosslinked coating does not contain heat-activated radical initiator.

In a second aspect according to the first aspect, the crosslinked coating contains UV-activated radical initiator.

In a third aspect according to any preceding aspect, the microporous membrane support comprises polymer selected from ultra-high molecular weight polyethylene, polyvinylidene fluoride, and polyphenylsulfone.

In a fourth aspect according to any preceding aspect, the hydrophilic groups are present on the crosslinked fluorinated ionomer at an equivalent weight in a range from 380 to 620 grams per equivalent, hydrophilic groups.

A fifth aspect according to any preceding aspect having a dye-binding capacity of at least 5 micrograms/cm2.

A sixth aspect according to any preceding aspect, having a (CH₃/H₂O mixture) wettability of less than 92 weight percent CH₃.

A seventh aspect according to any preceding aspect, having an isopropyl alcohol flow time of less than 4092 seconds at 14.2 psi/500 ml/17.35 cm² at room temperature.

An eighth aspect according to any preceding aspect, having a flow loss of 80 percent or less compared to the uncoated microporous membrane support when measured using 500 milliliters of isopropyl alcohol at a pressure of 14.2 psi.

A ninth aspect according to any preceding aspect, having a surface energy of at least 25 dynes per cm.

In a tenth aspect according to any preceding aspect, the microporous membrane comprises polymer selected from the group consisting of fluoropolymer, polysulfone, nylon, polyacrylonitrile, polyethylene, ultra-high molecular weight polyethylene, polyvinylidene fluoride, and polyphenylsulfone.

In an eleventh aspect, a filter comprises the microporous membrane composite of any preceding aspect.

In a twelfth aspect, a method of preparing a microporous membrane composite that comprises a microporous membrane support and a crosslinked fluorinated ionomer coating on a surface of the microporous membrane support, comprises: a) coating a microporous membrane with a liquid coating composition comprising fluorinated solvent and fluorinated ionomer dissolved or dispersed therein, the fluorinated ionomer derived from copolymerizing reactive units that comprise: i) fluorinated monomer comprising a fluorinated group and ethylenic unsaturation; ii) fluorinated monomer comprising ethylenic unsaturation and a functional group that is transformable into a hydrophilic group; iii) fluorinated bis-olefin monomer, and iv) fluorinated bromo-alkyl or iodo-alkyl chain transfer agent; and b) exposing the coated fluorinated ionomer to electromagnetic radiation to cause the reactive units to react to form a crosslinked fluorinated ionomer.

In a thirteenth aspect according the twelfth aspect, the fluorinated ionomer further comprises one or more of iodine and bromine atoms at a terminal position, wherein at least 90% by weight of the fluorinated ionomer has a particle size below 200 nanometers, and wherein the fluorinated ionomer is derived from copolymerizing reactive units that comprise: i) fluorinated monomer comprising a fluorinated group and ethylenic unsaturation; ii) fluorinated monomer comprising ethylenic unsaturation and a functional group that is transformable into a hydrophilic group; iii) bis-olefin monomers selected from formulae (OF-1), (OF-2), (OF-3) where: (OF-1) has the formula

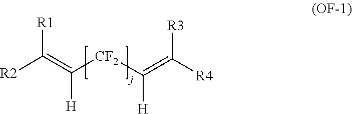

wherein j is an integer between 2 and 10, preferably between 4 and 8, and R1, R2, R3, R4, equal or different from each other, are H, F or C1 to C5 alkyl or (per)fluoroalkyl group; (OF-2) has the formula

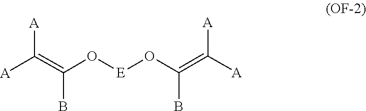

wherein each A is independently selected from F, Cl, and H; each B is independently selected from F, Cl, H and ORB, wherein RB is a branched or straight chain alkyl radical which can be partially, substantially, or completely fluorinated or chlorinated; E is a divalent group having 2 to 10 carbon atom, optionally fluorinated, which may include ether linkages; (OF-3) has the formula:

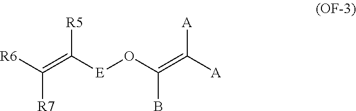

wherein E, A, and B have the same meaning as above defined; R5, R6, R7 is each independently H, F, or C1-5 alkyl or (per)fluoroalkyl group; and iv) fluorinated chain transfer agent of the formula R_{f}(I)ₓ(Br)_{y}, wherein R_{f} is a fluoroalkyl or (per)fluoroalkyl or a (per)fluorochloroalkyl group having from 1 to 10 carbon atoms, and wherein x and y are integers from 0 to 2, with 1≤x+≤2.

In a fourteenth aspect according to the twelfth or thirteenth aspect, the microporous membrane comprises polymer selected from the group consisting of fluoropolymer, polysulfone, nylon, polyacrylonitrile, polyethylene, ultra-high molecular weight polyethylene, polyvinylidene fluoride, and polyphenylsulfone.

In a fifteenth aspect according to any of the twelfth through fourteenth aspects, the fluorinated monomer comprising a fluorinated group and ethylenic unsaturation comprises tetrafluoroethylene.

In a sixteenth aspect according to any of the twelfth through fifteenth aspects, the functional group that is transformable into a hydrophilic group is selected from the group consisting of: —SO₂F, —COOR, —COF, and combinations of these, wherein R is a C1 to C20 alkyl radical or a C6 to C20 aryl radical.

A seventeenth aspect according to any of the twelfth through sixteenth aspects further comprises: continuously applying the liquid coating composition to a moving microporous membrane support, and continuously curing the liquid coating composition applied to the microporous membrane support by passing the moving microporous membrane support and the applied liquid coating composition through electromagnetic radiation.

In an eighteenth aspect according to any of the twelfth through seventeenth aspects, the liquid coating composition does not contain thermally-activated radical initiator.

In a nineteenth aspect according to any of the twelfth through eighteenth aspects, the liquid coating composition does not contain a radical initiator.

In a twentieth aspect according to any of the twelfth through nineteenth aspects, the liquid coating composition contains a radiation-activated radical initiator

A twenty-first aspect according to any of the twelfth through twentieth aspects further comprises after exposing the coated fluorinated ionomer to electromagnetic radiation to cause the reactive units to react to form a crosslinked fluorinated ionomer, contacting the membrane with solvent to remove un-reacted reactive units from the crosslinked fluorinated ionomer.

A twenty-second aspect according to any of the twelfth through twenty-first aspects further comprises converting —SO₂F, —COOR, or —COF groups to hydrophilic groups by contacting the crosslinked fluorinated ionomer sequentially with base and then acid.

A twenty third aspect is a microporous membrane composite prepared according to any of the twelfth through twenty-second aspects.

1. A microporous membrane composite comprising:
a microporous membrane support; and
a hydrophilic, crosslinked fluorinated ionomer coating on a surface of the microporous membrane support, the crosslinked fluorinated ionomer comprising:
fluorinated polymer backbone, and
hydrophilic groups attached to the fluorinated backbone, wherein the hydrophilic groups comprise groups selected from —SO₃H, —COOH, and PO₃H,
wherein the crosslinked coating does not contain heat-activated radical initiator.

2. The microporous membrane composite of claim 1, wherein the crosslinked coating contains UV-activated radical initiator.

3. The microporous membrane composite of claim 1, wherein the microporous membrane support comprises polymer selected from ultra-high molecular weight polyethylene, polyvinylidene fluoride, and polyphenylsulfone.

4. The microporous membrane composite of claim 1, wherein the hydrophilic groups are present on the crosslinked fluorinated ionomer at an equivalent weight in a range from 380 to 620 grams per equivalent, hydrophilic groups.

5. The microporous membrane composite of claim 1 having a dye-binding capacity of at least 5 micrograms/cm₂.

6. The microporous membrane composite of claim 1 having a (CH₃/H₂O mixture) wettability of less than 92 weight percent CH₃.

7. The microporous membrane composite of claim 1 having an isopropyl alcohol flow time of less than 4092 seconds at 14.2 psi/500 ml/17.35 cm² at room temperature.

8. The microporous membrane composite of claim 1 having a flow loss of 80 percent or less compared to the uncoated microporous membrane support when measured using 500 milliliters of isopropyl alcohol at a pressure of 14.2 psi.

9. The microporous membrane composite of claim 1 having a surface energy of at least 25 dynes per cm.

10. The microporous membrane composite of claim 1, wherein the microporous membrane comprises polymer selected from the group consisting of fluoropolymer, polysulfone, nylon, polyacrylonitrile, polyethylene, ultra-high molecular weight polyethylene, polyvinylidene fluoride, and polyphenylsulfone.

11. A filter comprising the microporous membrane composite of claim 1.

12. A method of preparing a microporous membrane composite that comprises a microporous membrane support and a crosslinked fluorinated ionomer coating on a surface of the microporous membrane support, the method comprising:
a) coating a microporous membrane with a liquid coating composition comprising fluorinated solvent and fluorinated ionomer dissolved or dispersed therein, the fluorinated ionomer derived from copolymerizing reactive units that comprise:
i) fluorinated monomer comprising a fluorinated group and ethylenic unsaturation;
ii) fluorinated monomer comprising ethylenic unsaturation and a functional group that is transformable into a hydrophilic group;
iii) fluorinated bis-olefin monomer, and
iv) fluorinated bromo-alkyl or iodo-alkyl chain transfer agent, and
b) exposing the coated fluorinated ionomer to electromagnetic radiation to cause the reactive units to react to form a crosslinked fluorinated ionomer.

13. The method of claim 12, wherein the fluorinated ionomer further comprises one or more of iodine and bromine atoms at a terminal position,
wherein at least 90% by weight of the fluorinated ionomer has a particle size below 200 nanometers, and
wherein the fluorinated ionomer is derived from copolymerizing reactive units that comprise:
i) fluorinated monomer comprising a fluorinated group and ethylenic unsaturation;
ii) fluorinated monomer comprising ethylenic unsaturation and a functional group that is transformable into a hydrophilic group;
iii) bis-olefin monomers selected from formulae (OF-1), (OF-2), (OF-3) where: (OF-1) has the formula 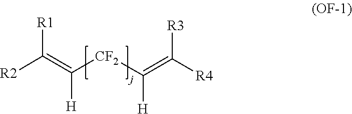
wherein j is an integer between 2 and 10, preferably between 4 and 8, and R1, R2, R3, R4, equal or different from each other, are H, F or C1 to C5 alkyl or (per)fluoroalkyl group;
(OF-2) has the formula 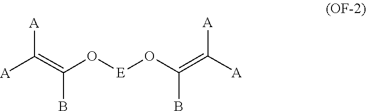
wherein each A is independently selected from F, Cl, and H; each B is independently selected from F, Cl, H and ORB, wherein RB is a branched or straight chain alkyl radical which can be partially, substantially, or completely fluorinated or chlorinated; E is a divalent group having 2 to 10 carbon atoms, optionally fluorinated, which may include ether linkages;
(OF-3) has the formula: 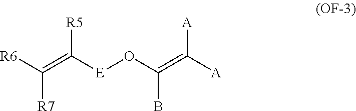
wherein E, A, and B have the same meaning as above defined; R5, R6, R7 is each independently H, F, or C1-5 alkyl or (per)fluoroalkyl group; and
iv) fluorinated chain transfer agent of the formula R_{f}(I)ₓ(Br)_{y}, wherein R_{f} is a fluoroalkyl or (per)fluoroalkyl or a (per)fluorochloroalkyl group having from 1 to 10 carbon atoms, and wherein x and y are integers from 0 to 2, with 1≤x+y≤2.

14. The method of claim 12, wherein the microporous membrane comprises polymer selected from the group consisting of fluoropolymer, polysulfone, nylon, polyacrylonitrile, polyethylene, ultra-high molecular weight polyethylene, polyvinylidene fluoride, and polyphenylsulfone.

15. The method of claim 12, wherein the fluorinated monomer comprising a fluorinated group and ethylenic unsaturation comprises tetrafluoroethylene.

16. The method of claim 12, wherein the functional group that is transformable into a hydrophilic group is selected from the group consisting of: —SO₂F, —COOR, —COF, and combinations of these, wherein R is a C1 to C20 alkyl radical or a C6 to C20 aryl radical.

17. The method of claim 12, further comprising:
continuously applying the liquid coating composition to a moving microporous membrane support, and
continuously curing the liquid coating composition applied to the microporous membrane support by passing the moving microporous membrane support and the applied liquid coating composition through electromagnetic radiation.

18. The method of claim 12, wherein the liquid coating composition does not contain thermally-activated radical initiator.

19. The method of claim 12, wherein the liquid coating composition does not contain a radical initiator.

20. The method of claim 12, wherein the liquid coating composition contains a radiation-activated radical initiator

21. The method of claim 12, further comprising, after exposing the coated fluorinated ionomer to electromagnetic radiation to cause the reactive units to react to form a crosslinked fluorinated ionomer, contacting the membrane with solvent to remove un-reacted reactive units from the crosslinked fluorinated ionomer.

22. The method of claim 12, further comprising converting —SO₂F, —COOR, or —COF groups to hydrophilic groups by contacting the crosslinked fluorinated ionomer sequentially with base and then acid.

23. A microporous membrane composite prepared according to claim 12.
